(19) United States
(12) Patent Application Publication
(10) Pub. No.: US 2003/0093552 A1
(43) Pub. Date: May 15, 2003

(54) Data communication system, data communication method, and computer-readable recording medium for recording program applied to data communication system

(75) Inventors: Tetsu Nonogaki, Hamamatsu-shi (JP); Kosei Terada, Hamamatsu-shi (JP); Takeshi Kikuchi, Hamana-gun (JP)

Correspondence Address: Pillsbury Winthrop LLP, Intellectual Property Group, Suite 2800, 725 South Figueroa Street, Los Angeles, CA, 90017-5406, US

(73) Assignee: Yamaha Corporation, Hamamatsu-shi (JP)

(21) Appl. No.: 10/294,336

(22) Filed: Nov. 14, 2002

(30) Foreign Application Priority Data
Nov. 15, 2001 (JP) P2001-350247

(51) Int. Cl. G06F 15/16; G06F 12/14; G06F 11/30; H04L 9/32; H04L 9/00

(52) U.S. Cl. 709/237; 709/228; 713/200

(57) ABSTRACT

A server apparatus constituting a data communication system including the server apparatus and a client terminal capable of communicating together includes: a storing device which stores a pre-shared key and a Hash function which are jointly owned in the client terminal; a receiving device for receiving a predetermined data and a first Hash value supplied from the client terminal; a producing device for employing the received predetermined data and the pre-shared key as an argument and producing a second Hash value by using the Hash function; and a comparing device for comparing the produced second Hash value with the received first Hash value and judging as to whether the predetermined data is altered or not.

### BACKGROUND OF THE INVENTION

The present invention relates to a data communication system, a data communication method, and computer-readable recording medium for recording thereon a program applied to this data communication system, and, more specifically, is capable of simply preventing an alteration of data executed while the data is transmitted/received by utilizing a Hash function.

Conventionally, there is such a method for generating a pseudo-random member (Hash value) having a fixed length, based upon original sentence data by employing a Hash function, and for comparing the pseudo-random numbers with each other at both ends of a communication path in order to detect as to whether or not an original sentence has been altered during data communications. Since this detection method employs the non-reversible one-direction function, the original sentence cannot be reproduced from the Hash value. Further, it is practically very difficult to form another message data upon which the same hash value may be produced based.

When data is transmitted/received, if the data to be processed and a hash value produced based upon this data are transmitted at the same time, a hash value is similarly produced with respect to data received on the reception side, and this produced hash value is compared with the transmitted hash value, so that it is possible to check as to whether or not this received data has been altered.

However, in such a case that transmission data is altered during data communication and furthermore a hash value to be transmitted is replaced by such a hash value which has been formed based upon the altered data, a fact of this alternation cannot be detected on the reception side.

### SUMMARY OF THE INVENTION

The present invention has been made to solve the above-described problem of the related art, and therefore, is directed to such a technical idea that not only a hash value is produced with respect to subject data, but also such a hash value containing a pre-shared key is produced, while this pre-shared key has been previously and commonly used between a server and a client.

Then, in this technical idea of the present invention, the pre-shared key does not flow through a communication path as a common value which has been commonly used between the server and the client, and thus, this pre-shared key cannot be stolen, or tapped by a third party having ill-intention. As a consequence, even when the third party tries to alter data, since this third party cannot know the pre-shared key, a hash value cannot be produced by this third party. Also, since the hash value is produced by the non-reversible one-directional function, the pre-shared key cannot be specified from the original hash value.

In order to solve the aforesaid object, the invention is characterized by having the following arrangement.

(1) A server apparatus constituting a data communication system including the server apparatus and a client terminal capable of communicating together, the server comprising:

a storing device which stores a pre-shared key and a Hash function which are jointly owned in the client terminal;

a receiving device for receiving a predetermined data and a first Hash value supplied from the client terminal;

a producing device for producing a second Hash value by performing a calculation of the Hash function which employs the received predetermined data and the pre-shared key as an argument; and

a comparing device for comparing the produced second Hash value with the received first Hash value and judging as to whether the predetermined data is altered or not.

(2) The server apparatus according to (1), wherein, in the client terminal, the Hash value is produced by employing the predetermined data and the pre-shared key as the argument of the Hash function.

(3) The server apparatus according to (1), wherein the Hash function is a function for producing, the second Hash value, a pseudo-random number having a fixed length from a given original sentence.

(4) The server apparatus according to (1), wherein the Hash function is a message digest 5 function.

(5) The server apparatus according to (1), wherein the predetermined data include a data concerning a purchase of contents data.

(6) The server apparatus according to (1), wherein the predetermined data include identification data attached to contents data previously sent from the server apparatus to the client terminal, and recognition data produced in response to a receipt confirmation operation, by the client terminal, of the contents data to which the identification data is attached.

(7) A client terminal constituting a data communication system including a server apparatus and the client terminal capable of communicating together, the server comprising:

a storing device which stores a pre-shared key and a Hash function which are jointly owned in the server apparatus;

a receiving device for receiving a predetermined data and a first Hash value supplied from the server apparatus;

a producing device for producing a second Hash value by performing a calculation of the Hash function which employs the received predetermined data and the pre-shared key as an argument; and

a comparing device for comparing the produced second Hash value with the received first Hash value and judging as to whether the predetermined data is altered or not.

(8) The client terminal according to (7), wherein, in the server apparatus, the Hash value is produced by employing the predetermined data and the pre-shared key as the argument of the Hash function.

(9) The client terminal according to (7), wherein the Hash function is a function for producing the second Hash value which is a pseudo-random number having a fixed length from a given original sentence.

(10) The client terminal according to (7), wherein the Hash function is a message digest 5 function.

(11) The client terminal according to (7), wherein the predetermined data include a data concerning a purchase of contents data.

(12) The client terminal according to (7), wherein the predetermined data include identification data attached to contents data previously purchased by the client terminal, and recognition data produced in response to a receipt confirmation operation, by the client terminal, of the contents data to which the identification data is attached and sent from the client terminal to the server apparatus.

(13) A method of communicating data between a client terminal and a server apparatus constituting a data communication system, the method comprising the steps of:

storing, in the server apparatus, a pre-shared key and a Hash function which are jointly owned in the client terminal;

receiving a predetermined data and a first Hash value supplied from the client terminal;

producing a second Hash value by performing a calculation of the Hash function which employs the received predetermined data and the pre-shared key as an argument; and

comparing the produced second Hash value with the received first Hash value and judging as to whether the predetermined data is altered or not.

(14) A computer program which causes a server apparatus to execute the method according to (13).

(15) A method of communicating data between a client terminal and a server apparatus constituting a data communication system, the method comprising the steps of:

storing, in the client terminal, a pre-shared key and a Hash function which are jointly owned in the server apparatus;

receiving a predetermined data and a first Hash value supplied from the server apparatus;

producing a second Hash value by performing a calculation of the Hash function which employs the received predetermined data and the pre-shared key as an argument; and

comparing the produced second Hash value with the received first Hash value and judging as to whether the predetermined data is altered or not.

(16) A computer program which causes a server apparatus to execute the method according to (15).

### BRIEF DESCRIPTION OF THE DRAWINGS

FIG. 1 is a schematic block diagram for indicating an entire arrangement of a data communication system according to the present invention.

FIG. 2 is a structural diagram for indicating an operation flow as to a contents delivery executed in the data communication system of the present invention.

FIG. 3 is a flow chart for describing a flow operation of issuing a key file in the data communication system of the present invention.

FIG. 4 is a flow chart for explaining a process routine of a use restriction releasing operation in the data communication system of the present invention.

### DETAILED DESCRIPTION OF PREFERRED EMBODIMENTS

An embodiment according to the present invention will now be described with reference to data which is transmitted/received between a server and a client, concretely speaking, a musical score data representative of musical score is transmitted/received as contents data. It should be noted that contents data to be delivered may be widely applied to the present invention if subject contents data maybe digitally processed, for example, not only sheets of music, but also music data, computer programs, image data, and the like.

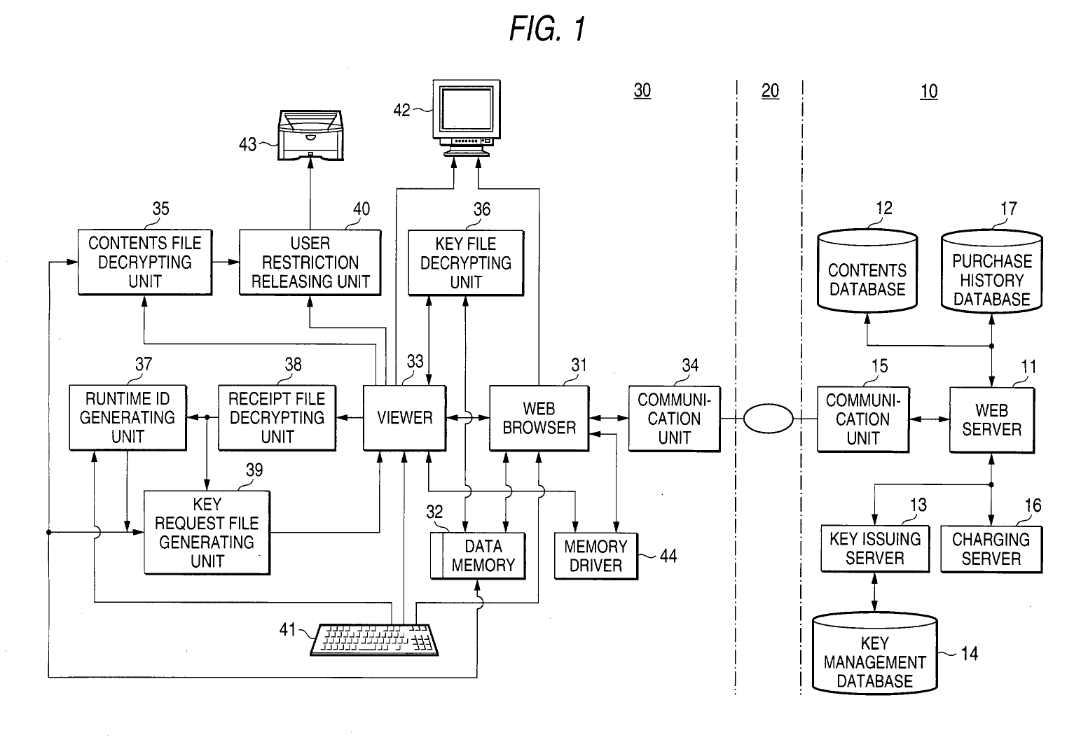

FIG. 1 is a block diagram for schematically indicating an entire arrangement of a data communication system according to the present invention. In this drawing, reference numeral 10 shows a delivering computer (will be referred to as a “server” hereinafter) installed at a contents provider (delivery dealer) Reference numeral 20 indicates an information communication network which is constituted by a communication line such as the Internet and a LAN (Local Area Network). Reference numeral 30 represents a large number of unspecified data-delivered computers (will be referred to as a “client” hereinafter). It is so assumed that when the client 30 is communicated with the server 10 in the data communication system of the present invention, this client 30 is equipped with the functions shown in this drawing.

In the above-described server 10, a Web server 11 transmits contents data and a contents file via both a communication unit 15 and the information communication network 20 to the client 30 in accordance with a predetermined communication protocol in response to a request issued from the client 30, while this contents data is stored in a contents database 12, and the contents file contains a key file issued from a key management database 14.

The contents file contains contents identification data CID (Contents Id.) for identifying the individual contents data, and runtime recognition data RID (Runtime Id.) received from the client 30 in combination with the contents data.

A contents database 12 is constructed of a storage apparatus having a large capacity, into which a plurality of contents data have been encrypted and stored. The above-described plural contents data are made of a large number of data such as musical notes and music, and correspond to musical score data used to print out musical scores. It should be noted that the musical score data may be constituted by image data in which musical score are grasped as figures.

Reference numeral 16 shows a charging server. The charging server 16 issues a receipt file every time this charging server 16 accepts a purchase request of contents file from the client 30. In this receipt file, detailed information of contents which are purchased by the client 30 has been produced to be embedded. In other words, in the case that the purchased contents data is a musical score data, purchase history data PID (Purchase Id.) indicative of a music title thereof, a name of a composer thereof, a purchase money amount, a purchase day/time, and the like has been produced to be embedded in this receipt file. The contents identification data CID has been embedded in this receipt file. Then, the receipt file into which the above-described purchase history data PID and the above-explained contents identification data CID have been embedded is stored in the purchase history database 17.

Reference numeral 14 indicates a key management database. This key management database 14 stores thereinto a key file, and transmits/receives the key file with respect to a key issuing server 13, while this key file is constituted by the purchase history data PID and the contents identification data CID, which are produced by the server 10.

The key issuing server 13 transmits the produced key file via the Web server 11 and a communication unit 15 to the client 30, and receives a key request file transmitted from the client 30. This key issuing server 13 is provided with a decrypting/producing function of a Hash function. In this key issuing server 13, a calculating process operation is carried out based upon the Hash function, while the purchase history data PID, the contents identification data CID, and the like are employed as an argument.

The above-described Hash function corresponds to such a calculation manner capable of producing a pseudo-random number having a fixed length from a given original sentence. This produced value (namely, pseudo-random number) is referred to as a “hash value”. Since this hash value contains a non-reversible hash function, it is practically difficult to reproduce the original sentence from the hash value. An embodiment of the present invention will be explained under such an initial condition that an algorithm is employed which is established based upon the MD 5 (Message Digest 5) which has been widely used as the hash function in general.

Next, in the contents-delivered computer of the client 30, a Web browser 31 reads various sorts of data such as contents files and programs and stores these read data and contents files into a data memory 32, and sends out various sorts of control instructions with respect to a viewer 33, and on the other hand, sends out the various sorts of data and the programs via a communication unit 34 to the server 10.

The viewer 33 transmits/receives data with respect to the server 10 in conjunction with the Web browser 31, and on the other hand, reads contents data of a contents file and a key file, which have been stored in the data memory 32, and then supplies these contents data and key file to the client 30 for use purposes.

Then, a contents file decrypting unit 35 which is controlled by the viewer 33 decrypts an encrypted contents file which has been stored in the data memory 32 and is transmitted from the server 10. The contents file decrypting unit 35 supplies the restored contents data to a use restriction releasing unit 40.

The key file decrypting unit 36 which is controlled by the viewer 33 is provided with a decrypting function of Hash function. This key file decrypting unit 36 decrypts such a key file which has been stored in the data memory 32 and has been processed by the Hash function so as to restore purchase history data PID, contents identification data CID, and runtime recognition data RID. A runtime ID generating unit 37 for generating the above-described runtime recognition data RID contains a random number generating for generating random numbers having a plurality of bits according to elapsed time, and produces as the runtime recognition data RID such a random number which is generated at designated timing.

Next, reference numeral 38 shows a receipt file decrypting unit. The receipt file decrypting unit 38 decrypts a receipt file transmitted in combination with a contents file from the server 10, sends the purchase history data PID and the contents identification data CID to a key request file producing unit 39, and initiates the runtime ID generating unit 37 so as to send out the runtime recognition data RID to a key request file producing unit 39.

The key request file producing unit 39 is equipped with a producing function of a Hash function. While the purchase history data PID, the contents identification data CID, the runtime recognition data RID, and the like are employed as a argument, the key request file producing unit 39 executes a calculating process operation based upon the Hash function so as to produce a key request file.

Reference numeral 40 indicates the use restriction releasing unit. When it is so judged that a decryption result of a key file decrypted by the key file decrypting unit 36 is correct, the use restriction releasing unit 40 releases a use restriction of the contents file, so that contents data entered from the contents file decrypting unit 35 can be outputted from this use restriction releasing unit 40.

The client 30 is provided with an input key 41, a display 42, a printer 43, and a memory driver 44 other than the above-explained structural units. The printer 43 functions as an external recording appliance. The input key 41 is constructed of a character key, a numeral key, a mouse, and the like. The input key 41 inputs an instruction signal by operating this key, and supplies input data to the Web browser 31, and the runtime ID generating unit 37. The display 42 visually displays thereon a character, a musical score data, a figure, and the like in response to an image signal which is produced by the Web browser 31, the viewer 33, and the like. The printer 43 may print out the character, the musical score, the figure, and the like, which are produced by the Web browser 31, the viewer 33, and the like. Alternatively, this printer 43 may be readily replaced by employing either an optical recording apparatus or a magnetic recording apparatus. It should be noted that the memory driver 44 is controlled by the Web browser 31, the viewer 33, and other programs, and data and programs are written into, or read from a recording medium of either the optical recording apparatus or the magnetic recording apparatus.

The data communication system of the present invention is arranged in the above-explained manner. Furthermore, in the server 10, both a program capable of realizing the Web server 11 and a dedicated program capable of realizing the key issuing server 13 are stored into a program memory of a relatively large-scaled computer.

The contents file constructed of the contents data and the contents identification data CID is stored/recorded in the contents database 12. In the case that musical scores are stored/recorded in the contents database 12, music titles, names of composers, genres of music pieces, difficulty degrees of music plays, and sales prices may be contained in order to easily retrieve the respective musical scores in the contents database 12. These contents can be added and/or updated any time.

On the other hand, in the client 30, both a program capable of realizing the Web browser 31 and a program capable of realizing the viewer 33 and the runtime ID generating unit 37 are stored in a program memory contained in a contents-delivered computer. In this case, these programs may be downloaded from either the server 10 or another computer. Alternatively, either an optical recording medium or a magnetic recording medium, which stores thereinto the above-explained programs, may be delivered to the client 30 in a physical distribution manner, and then, these programs may be installed.

Then, at this time, the server 10 gives a client key “KEY 1” and a server key “KEY 2” to the client 30. The client key “KEY 1” and the server key “KEY 2” correspond to pre-shared keys which are used to mutually identify the client 30 and the server 10 with each other, and are stored as “secret keys.”

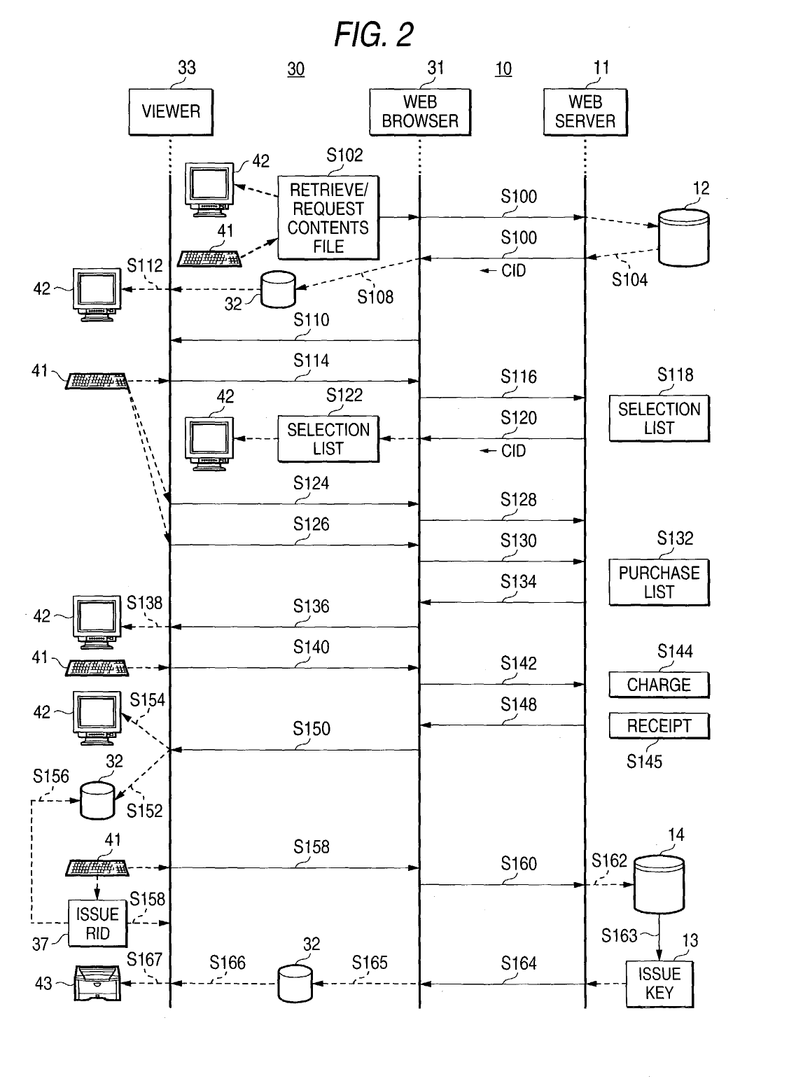

Next, process steps of contents delivering operations executed in the data communication system having the above-described arrangement, according to the present invention, will now be described in detail with reference to FIG. 2. In this drawing, when are quest of delivering a specific content is issued, the Web browser 31 of the client 30 is first initiated, and the input key 41 is manipulated so as to make a request to the Web server 11 for a contents file (step S100) In this case, an operator on a contents-delivered computer accesses the server 10, causes the display 42 to display thereon menu data supplied from this server 10, and manipulates the input key 41 so as to retrieve a desirable musical score and to make a request for the extracted musical score (step S102).

In response to this operation, the Web server 11 of the server 10 reads out the requested contents file from the contents database 12 (stepS104), and transmits a portion of this contents data to the Web browser 31 of the client 30 in combination with the contents identification data CID (step S106). The Web browser 31 stores this portion of the transmitted contents data into the data memory 32 (step S108) and, initiates the viewer 33 (step S110). In the viewer 33, the contents file decrypting unit 35 reads out the contents data stored in the data memory 32, and decrypts this read contents data so as to decode the contents file. Then, the viewer 33 displays a portion of the decoded contents data on the display 42 (step S112). In this case, the musical score indicated on the display 42 corresponds to the portion of the contents data. This musical score cannot be printed out because of the function of the use restriction releasing unit 40. In order to avoid such a fact that the displayed musical score is duplicated as a hard copy, this musical score may be compressed in a predetermined smaller compression rate than the normal compression rate, or display resolution of this musical score may be made coarser than the normal display resolution.

Then, when the input key 41 is manipulated so as to request a purchase of this displayed musical score, a selection request is issued from the viewer 33 to the Web browser 31 (step S114), and the Web browser 31 transmits this selection request to the Web browser 31 (step S116). At this time, the viewer 33 drives a sound source circuit which is not shown in the drawing and is built in this data communication system, and generates music sound based upon either the contents data (musical score) included in the content or other data, and may use this music sound as an element capable of judging a selection of the above-explained musical score.

On the other hand, in the server 10, when the Web server 11 receives the selection request, the Web server 11 forms a list of the relevant musical scores (step S118), and transmits this formed list to the client 30 (step S120). Then, in the client 30, the Web browser 31 receives the above-described selection list, and displays a content of this selection list on the display 30 (step S122). Since this selection list contains the contents identification data CID, a title of music, a name of a composer, and the like are displayed on the display 42. At the same time, a menu is displayed on the display 42, while this menu inquires of the operator as to whether or not a contents file is newly added, the contents file which has already been selected are canceled, and the selection of the contents file is accomplished.

When the input key 41 is manipulated so as to instruct that the contents file is added, the selected contents file is canceled, or the selection of the contents file is ended, the viewer 33 notifies this instruction to the Web browser 31 (steps S124 and S126). In the case that the instruction of adding, or canceling the contents file is notified, the Web browser 31 notifies this notification to the Web server 11 (step S128), and again commences the above-described request operation of the contents file (step S100). As a consequence, portions of the requested contents file are sequentially added to the selection list in accordance with the process sequential operations defined from the step S100 to the step S122. In the case that the canceling of the selected contents file is instructed, the Web server 11 deletes the canceled contents file from the selection list which has been formed in the above-described manner, and then transmits the selection list to the client 30 (step S120), and the Web browser 31 updates the selection list in the client 30 (step S122).

On the other hand, in such a case that the end of the contents file selection is instructed from the viewer 33 (step S126), the Web browser 31 notifies this ending instruction of the contents file to the server 10 (step S130). Then, in the server 10, such a purchase list is formed in which purchase money amounts are contained in the contents of the selection list formed by the Web server 11 (step S132), and then, both this purchase list and a confirmation of a purchase are transmitted to the client 30 (step S134).

The client 30 which has received the purchase list and the confirmation of the purchase notifies to the viewer 33 such a fact that the Web browser 31 confirms the purchase list and the purchase (step S136), and then, the viewer 33 displays both the purchase list and the confirmation of the purchase on the display 42 (step S138). In this case, the title of music, the name of the composer, the purchase money amount, and the like, which have been selected in the above-described manner, are displayed on the display 42. Further, an inquiry as to a settlement method (for instance, number of credit card: CNO) is displayed on this display 42 as a confirmation of a purchase method. Then, in the case that the input key 41 is manipulated so as to request the purchase and to enter the settlement method in the client 30, the viewer 33 notifies the purchase request, the settlement method (number of credit card: CNO) to the Web browser 31 (step S140), and then, the Web browser 31 transmits this purchase request and the settlement method to the server 10 (step 142).

When the server 10 receives the above-described purchase request, settlement method, and the like, the Web server 11 responds to the above-explained purchase request, and executes a charging process operation in accordance with the received settlement method (step 144) Thereafter, a money amount equivalent to the charged fee is requested from the client 30. When the charging operation is carried out in this manner, the Web server 11 forms a receipt (step S145), and then, transmits such a receipt file which is formed based upon this receipt to the client 30 (step S148).

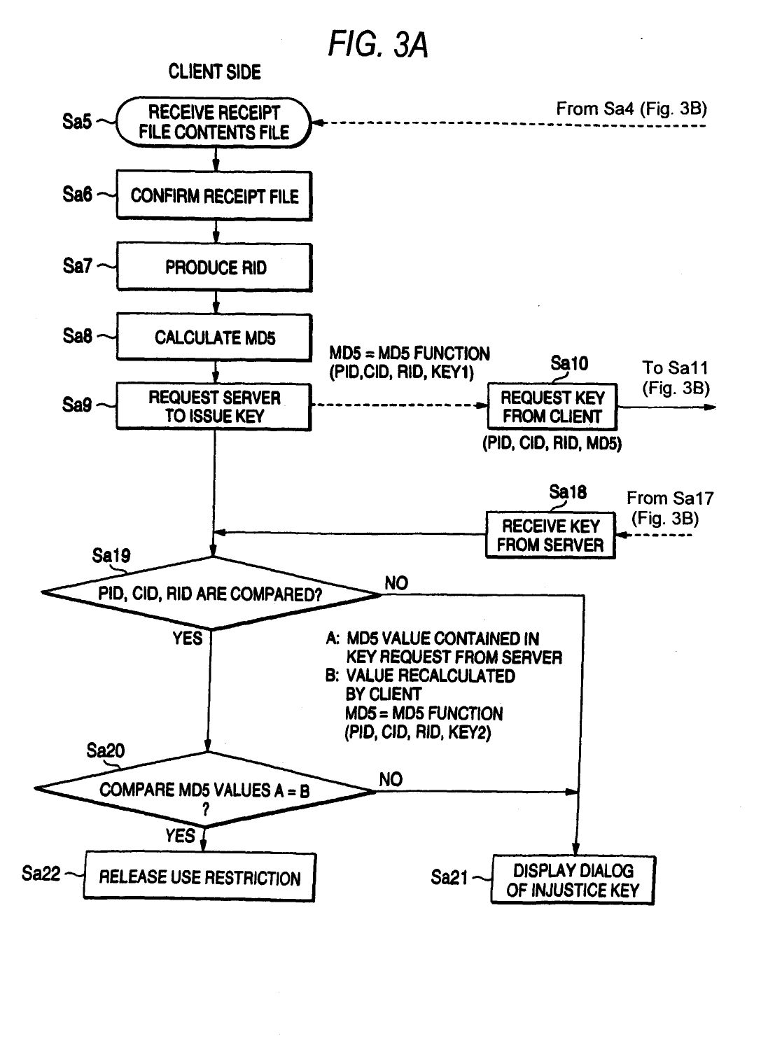

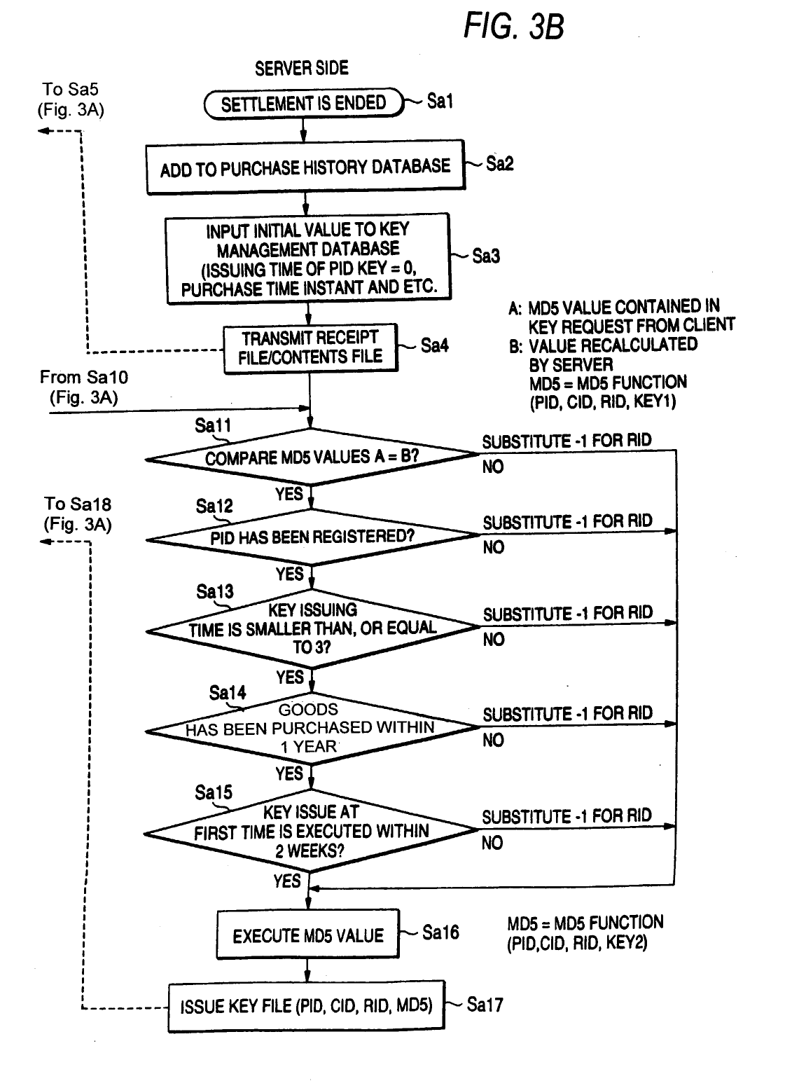

In this case, a flow operation defined by that a settlement for the above-described charging operation is accomplished, and thereafter, a receipt file is issued will now be described with reference to a flow chart indicated in FIG. 3. In this drawing, when the completion of the settlement executed on the side of the server 10 is confirmed at a step Sa1, the produced purchase history data PID is stored in the purchase history database 17 of the server 10 at a step Sa2. Then, in a step Sa3, an initial value (PID, key issuing time=0, purchase time instant, key issuing time instant of first time=0) is entered into the key management database 17, and then, a receipt file is issued in a step Sa4. It should also be noted that the above-described receipt file is constituted by all of encrypted contents data to be purchased, the purchase history data PID, the contents identification data CID, and URLs of contents data.

When the receipt file is issued in this manner and then the client 30 receives this receipt file, in FIG. 2, the Web browser 31 notifies the receipt file to the viewer 33 (step S150), and the viewer 33 stores this notified receipt file into the data memory 32 (step S152), and also displays titles of music pieces, names of composers, respective money amounts, and a total money amount of the purchased contents data (musical scores) on the display 42. Then, the viewer 33 indicates a receipt confirmation of the receipt file on the display 42 (step S154), and enters the receipt file into the receipt file decrypting unit 38.

Next, when the client 30 operates the input key 41 so as to confirm the reception, the runtime ID generating unit 37 is operated in response to the confirmation operation of this input key 41, and generates runtime recognition data RID based upon a random number having a plurality of bits which are synchronized with timing of this confirmation operation. This runtime recognition data RID is stored into the data memory 32 in correspondence with the above-described purchased contents data by the viewer 33 (step S156). Then, when the purchase history data PID and the contents identification data CID, which are derived from the receipt file decrypting unit 38, and the runtime confirmation data RID generated from the runtime ID generating unit 37 are entered into the key request file producing unit 39, the calculating process operation is carried out based upon the Hash function (MD 5 function).

In this case, a process flow operation defined by that the client 30 receives the receipt file and then accomplishes the calculating process operation based upon the Hash function (MD 5 function) will now be described with reference to a flow chart indicated in FIG. 3. In this drawing, when the client 30 receives both the encrypted contents file and the receipt file in a step Sa5, a confirmation of the receipt file is carried out due to the function of the receipt file decrypting unit 38 in a step Sa6. Next, runtime recognition data RID is produced in a step Sa7. Then, a calculating process operation is carried out based upon the Hash function (MD 5 function) in a step Sa8.

As to the above-described calculation of the Hash function (MD 5 function), while the above-described purchase history data PID, contents identification data CID, runtime recognition data RID, and also the previously stored client key “KEY 1” are employed as the argument of the Hash function (MD5 function), character strings of the above-explained various data PID, CID, RID, and KEY 1 are coupled with each other to perform the calculation of this Hash function. That is to say, assuming now that the character string of the data PID is “xxxx”, the character string of the data CID is “yyyy”, and the character string of the data RID is “zzzz”, if the values of the client key “KEY 1” are coupled with each other to perform the calculating process operation, then the following equation is given:

MD 5 function (xxxxyyyyzzzzKEY 1)=mmm, so that the hash value (MD 5) of the character string “mmm” is obtained. As a consequence, a key request file (PID, CID, RID, MD5) containing the above-described hash value (MD 5) is constituted in a step Sa9.

When the key request file is produced by the key request file producing unit 39 in this manner, the viewer 33 notifies this key request file to the Web browser 31 (step S158), and the Web browser 31 further transmits the key request file to the server 10 (step S160). Then, the server 10, which receives the key request file which has been constructed in the above-described manner, temporarily stores the received key request file via this Web server 11 into the key management database 14 (step S162).

As explained above, when the server 10 receives the key request file in a step Sa10 shown in FIG. 3, validity of each of the data as to the condition for issuing the key file is judged. In other words, in a step Sa11 of the flow chart shown in FIG. 3, the Web server 11 derives the data (PID, CID, RID) contained in the key request file transmitted from the client 30 (step S163 of FIG. 2), adds the client key “KEY 1” stored by the server 10 to this derived data, and while the added data are employed as the argument, the server 10 executes the calculation process operation which has been executed by the client 30: MD 5 function (xxxxyyyyzzzKEY 1). Then, a judgement is made as to whether or not the hash value (MD 5) obtained from this calculation process operation is made coincident with the hash value (MD 5) sent from the client 30. If the resultant hash value (MD 5) is different from the sent hash value (MD 5), then a negative value is substituted for the runtime recognition data RID. On the other hand, if the hash value (MD 5) sent from the client 30 is made coincident with the hash value (MD 5) calculated by the server 10, the process operation is advanced to a step Sa12.

In the step Sa12, a judgment is made as to whether or not the purchase history data is such a purchase history data which has been registered in the purchase history database 17. If the purchase history data PID corresponds to such a purchase history data which has not been registered, a negative value is substituted for the runtime recognition data RID. On the other hand, when it is so confirmed that the purchase history data PID has been registered in the purchase history database 17, the process operation is advanced to a step Sa13.

In this step sa13, an issuing time of the key file is judged. For instance, in the case that the issuing time of the key file is larger than, or equal to 3, a negative value is substituted for the runtime recognition data RID. On the other hand, in the case that the issuing time of the key file is smaller than, or 3, the process operation is advanced to a step Sa14.

In the step Sa14, a judgement is made of a time period from a preceding purchase of contents. For instance, in the case that the time period has passed longer than, or equal to 1 year, a negative value is substituted for the runtime recognition data RID. On the other hand, in such a case that 1 year has not yet elapsed from the preceding purchase of contents, the process operation is advanced to a step Sa15.

In this step Sa15, a judgement is made of a time period after the key file has been issued first time. For example, in the case that the time period has passed longer than, or equal to 2 weeks, a negative time is substituted for the runtime recognition data RID. On the other hand, in the case that a time period after the preceding key file has been issued is shorten than 2 weeks, the process operation is advanced to a step Sa16.

As explained above, when the validity of the key request file sent from the client 30 in the respective steps Sa11 to Sa15 is verified, the server 10 executes the calculating process operation based upon the Hash function (MD 5 function) so as to issue the key file in the Web server 11. In other words, in a step Sa16, while data (PID, CID, RID) are derived from the data contained in the key request file, the server 10 adds the server key “KEY 2” stored in this server 10 to the derived data (PID, CID, RID), and executes the calculating process operation based upon the Hash function (MD 5) by using the added result as an argument with respect to :

MD5 function (xxxxyyyyzzzzKEY 2). The server 10 obtains a hash value (MD 5) thereof.

It should be understood that in such a case that the validity of the key file transmitted from the client 30 is denied and then the negative values are substituted for the runtime recognition data RID in the respective steps Sa11 to Sa15, a hash value which is different from the above-explained hash value may be apparently obtained. In any cases, when the hash value (MD 5) is calculated in this manner, such a key file (PID, CID, RID, MD 5) containing this hash value (MD 5) is issued in a step Sa17 to be transmitted to the client 30 (step S164 in FIG. 2). In the client 30, the above-described key file is temporarily stored in the data memory 32 (step S165).

When the key file is issued from the server 10 in the above-described manner, the client 30 receives the key file in a step Sa18 of the flow chart of FIG. 3. First, a check is made as to whether or not the data (PID, CID, RID) of the transmitted key file is made coincident with the data (PID, CID, RID) of the key request file in a step Sa19. When it is so judged that these data are not made coincident with each other, the process operation is advanced to a step Sa21 in which such a dialog “key file is injustice” is displayed on the display 41. To the contrary, in the case that the respective data are made coincident with each other, and it is so judged that the key file is not injustice, the process operation is advanced to a step Sa20.

When the process operation is moved to the step Sa20, the key file stored in the data memory 32 is read to be supplied to the key file decrypting unit 36 (step S166 of FIG. 2). Then, the server key “KEY 2” stored by the client 30 is added to the read data (PID, CID, RID), and a calculating process operation based upon the Hash function (MD 5 function) is carried out in the key file decrypting unit 36 while the added result is employed as an argument as follows:

MD 5 function (xxxxyyyyzzzzKEY 2).

A judgement is made in a step Sa20 as to whether or not the hash value (MD 5) which is obtained by the result of the above-described calculating process operation is made coincident with the hash value (MD 5) transmitted from the server 10. When it is so judged that the calculated hash value (MD 5) is not made coincident with the transmitted hash value (MD 5), the process operation is advanced to a step Sa21. In this step Sa21, such a dialog “key file is injustice” is displayed on the display 42. To the contrary, when it is so judged that the calculated hash value is made coincident with the transmitted hash value, the process operation is advanced to a step Sa22 in which the use restriction may be released.

As apparent from the above-described explanation, while both the client key “KEY 1” and the server key “KEY 2” are used as the “pre-shared keys” which have been previously recognized by the client and the server, the client and the server independently execute the calculating process operations based upon the Hash function (MD 5 function) including the data which are uncertainly produced. As a result, secrecies in the communication path between the client and the server can be sufficiently highly maintained.

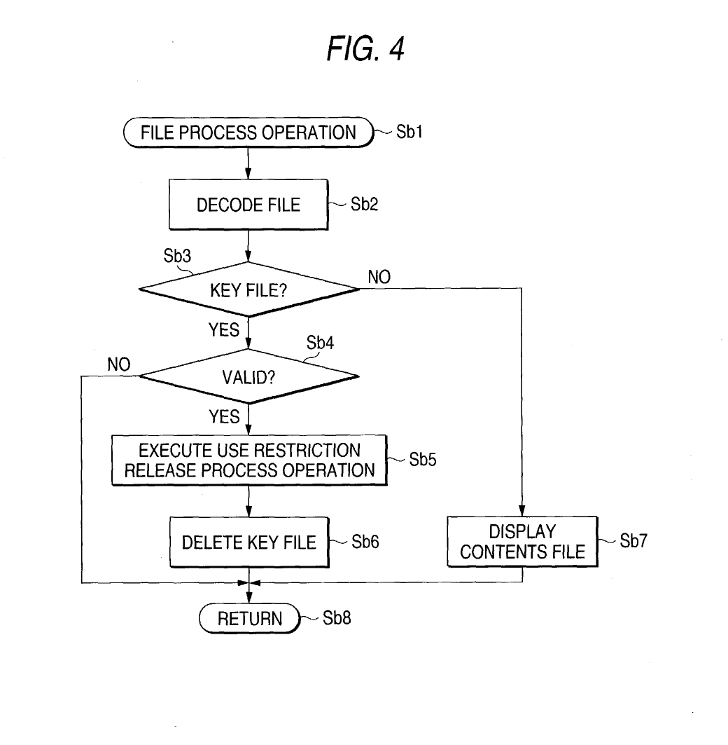

Next, a description will now be made of such a process flow operation that the client 30 prints out contents data which is downloaded from the server 10 based upon a flow chart of FIG. 4. First, when a process operation for opening a download-designated contents file is instructed by manipulating the input key 41, a file process routine is commenced in a step Sb1. Then, in a step Sb2, the designated contents file (contents file and key file) is read out from the data memory 32, the encrypted contents file is decrypted by the contents file decrypting unit 35 so as to decode the contents file, and then, a check is made in a step Sb3 as to whether or not the decoded contents file corresponds to the key file. When the decoded contents file corresponds to the key file, the process operation is advanced to a step Sb4. In this step Sb4, when it is so judged that the key file is valid, the process operation is advanced to a step Sb5 in which the use restriction is released (step Sa22). Then, the process operation is advanced to a step Sb6 in which the key file is deleted from the data memory 32. As a result, the key file cannot be read out again from the data memory 32.

On the other hand, as a result of the decoding operation executed in the above-explained step S62, in the case that the contents data is decoded, the process operation is advanced from the step S63 to a step S67. In this step S67, a content (musical score) of this contents data is displayed on the display 42. Then, in a step S68, the execution of the file processing routine is once ended. Under this condition, when a printing operation is instructed by manipulating the input key 41, a printing process operation is carried out by the printer 43.

As previously explained, since the key file has been deleted from the data memory 32, when the printing process operation of the first time is accomplished, the use restriction cannot be again released. As a consequence, in such a case that the client 30 again requests contents data, the client 30 can download a contents file in such a way that a new key request file is constituted in accordance with the file processing routine of FIG. 3 so as to request a key file.

As previously explained in detail, in accordance with the data communication system of the present invention, while the pre-shared key issued from the server is provided which may verify both the client and the server, the client independently constructs the key request file and also the server independently constitutes the key file based upon this pre-shared key, the identification data of the specific contents, the identification data which is produced by the client based upon this identification data, and the function value. This function value is obtained from the calculation result in such a way that the calculating process operation is carried out based upon the Hash function while the pre-shared key is employed as the argument.

As a consequence, since the hash value which is obtained from the calculating process operation based upon the Hash function is obtained in both the key request file and the key file, these key request/key files are not altered on the information network. Moreover, since the pre-shared key is employed in the argument (independent variable) of the Hash function, the security required in the data communication can be furthermore improved.

What is claimed is:

1. A server apparatus constituting a data communication system including the server apparatus and a client terminal capable of communicating together, the server comprising:
a storing device which stores a pre-shared key and a Hash function which are jointly owned in the client terminal;
a receiving device for receiving a predetermined data and a first Hash value supplied from the client terminal;
a producing device for producing a second Hash value by performing a calculation of the Hash function which employs the received predetermined data and the pre-shared key as an argument; and
a comparing device for comparing the produced second Hash value with the received first Hash value and judging as to whether the predetermined data is altered or not.

2. The server apparatus according to claim 1, wherein, in the client terminal, the Hash value is produced by employing the predetermined data and the pre-shared key as the argument of the Hash function.

3. The server apparatus according to claim 1, wherein the Hash function is a function for producing, the second Hash value, a pseudo-random number having a fixed length from a given original sentence.

4. The server apparatus according to claim 1, wherein the Hash function is a message digest 5 function.

5. The server apparatus according to claim 1, wherein the predetermined data include a data concerning a purchase of contents data.

6. The server apparatus according to claim 1, wherein the predetermined data include identification data attached to contents data previously sent from the server apparatus to the client terminal, and recognition data produced in response to a receipt confirmation operation, by the client terminal, of the contents data to which the identification data is attached.

7. A client terminal constituting a data communication system including a server apparatus and the client terminal capable of communicating together, the server comprising:
a storing device which stores a pre-shared key and a Hash function which are jointly owned in the server apparatus;
a receiving device for receiving a predetermined data and a first Hash value supplied from the server apparatus;
a producing device for producing a second Hash value by performing a calculation of the Hash function which employs the received predetermined data and the pre-shared key as an argument; and
a comparing device for comparing the produced second Hash value with the received first Hash value and judging as to whether the predetermined data is altered or not.

8. The client terminal according to claim 7, wherein, in the server apparatus, the Hash value is produced by employing the predetermined data and the pre-shared key as the argument of the Hash function.

9. The client terminal according to claim 7, wherein the Hash function is a function for producing the second Hash value which is a pseudo-random number having a fixed length from a given original sentence.

10. The client terminal according to claim 7, wherein the Hash function is a message digest 5 function.

11. The client terminal according to claim 7, wherein the predetermined data include a data concerning a purchase of contents data.

12. The client terminal according to claim 7, wherein the predetermined data include identification data attached to contents data previously purchased by the client terminal, and recognition data produced in response to a receipt confirmation operation, by the client terminal, of the contents data to which the identification data is attached and sent from the client terminal to the server apparatus.

13. A method of communicating data between a client terminal and a server apparatus constituting a data communication system, the method comprising the steps of:
storing, in the server apparatus, a pre-shared key and a Hash function which are jointly owned in the client terminal;
receiving a predetermined data and a first Hash value supplied from the client terminal;
producing a second Hash value by performing a calculation of the Hash function which employs the received predetermined data and the pre-shared key as an argument; and
comparing the produced second Hash value with the received first Hash value and judging as to whether the predetermined data is altered or not.

14. A computer program which causes a server apparatus to execute the method according to claim 13.

15. A method of communicating data between a client terminal and a server apparatus constituting a data communication system, the method comprising the steps of:
storing, in the client terminal, a pre-shared key and a Hash function which are jointly owned in the server apparatus;
receiving a predetermined data and a first Hash value supplied from the server apparatus;
producing a second Hash value by performing a calculation of the Hash function which employs the received predetermined data and the pre-shared key as an argument; and
comparing the produced second Hash value with the received first Hash value and judging as to whether the predetermined data is altered or not.

16. A computer program which causes a server apparatus to execute the method according to claim 15.
